(19) United States
(12) Patent Application Publication
(10) Pub. No.: US 2007/0064651 A1
(43) Pub. Date: Mar. 22, 2007

(54) Apparatus and method for performing handoff in cellular environments

(75) Inventors: Yong-Seok Kim, Suwon-si (KR); Ki-Young Han, Yongin-si (KR); Young-Hoon Kwon, Seongnam-si (KR); Soon-Young Yoon, Seoul (KR); Sung-Soo Hwang, Suwon-si (KR)

Correspondence Address: DILWORTH & BARRESE, LLP, 333 EARLE OVINGTON BLVD., SUITE 702, UNIONDALE, NY, 11553, US

(73) Assignee: Samsung Electronics Co., Ltd., Suwon-si (KR)

(21) Appl. No.: 11/501,135

(22) Filed: Aug. 8, 2006

(30) Foreign Application Priority Data
Aug. 8, 2005 (KR) 2005-0072085

(51) Int. Cl. H04Q 7/00

(52) U.S. Cl. 370/331; 370/320; 370/491; 455/560; 455/436

(57) ABSTRACT

Provided are an apparatus and a method for performing a handoff in a broadband cellular communication system with a frequency reuse factor of N by using both of two neighboring frequency allocations. The method includes determining, if a mobile station receives a signal from a second base station during communication with a second base station, whether frequency allocations of the two base stations are adjacent to each other, measuring and comparing signal strengths of the two base stations if the frequency allocations are adjacent to each other, sending a handoff request to the first base station if the signal strength of the first base station is less than or equal to the signal strength of the second base station, and simultaneously receiving signals of the two frequency allocations by simultaneously allocating portions of the frequency allocations to the mobile station according to the handoff request.

### PRIORITY

This application claims priority under 35 U.S.C. § 119 to a Korean application filed in the Korean Intellectual Property Office on Aug. 8, 2005 and assigned Serial No. 2005-72085, the disclosure of which is incorporated herein by reference.

### BACKGROUND OF THE INVENTION

1. Field of the Invention

The present invention relates generally to an apparatus and method for performing a handoff between two neighboring frequency allocations (FAs) in cellular environments, and in particular, to an apparatus and method for performing, when two neighboring base stations (BSs) use two neighboring FAs in a cellular environment with a frequency reuse factor of N, a handoff between the two neighboring BSs by using both of the two neighboring FAs.

2. Description of the Related Art

A cellular communication system has been proposed to overcome the restrictions of a service area and a subscriber capacity. In the cellular communication system, the service area is divided into a plurality of sub-areas (i.e., cells). Two cells spaced apart from each other by a sufficient distance use the same FA so that frequency resources can be spatially reused. Accordingly, the cellular communication system can accommodate a sufficient number of subscribers by increasing the number of spatially-distributed channels.

A handoff is a technique for providing a seamless call for a mobile user even when a mobile station (MS) communicating in one cell moves into another cell while the call is in progress, so as to ensure the mobility of the communicating MS in the cellular communication system.

FIG. 1 is a flowchart illustrating a conventional handoff process. The following description is made of a mobile assisted handoff (MAHO) scheme in which an MS measures a pilot strength (PS) of a source BS and a PS of a neighboring BS and provides the measured PSs to the source BS to determine whether to perform a handoff. The source BS is a BS that the MS is communicating with, and the neighboring BS is a BS that is adjacent to the source BS and transmits a pilot signal to the MS.

Referring to FIG. 1, the MS determines in step 101 if it receives a unique pilot signal of the neighboring BS. If so, the MS proceeds to step 103, and if not, it performs step 101 again. In step 103, the MS measures a PS of the received unique pilot signal.

In step 105, the MS compares the measured PS with a predetermined threshold value. If the measured PS is smaller than the predetermined threshold value (PS<Th), the MS returns to step 101 to determine whether it receives a pilot signal from another neighboring BS.

On the other hand, if the measured PS is greater than or equal to the predetermined threshold value (PS≧Th), the MS proceeds to step 107. In step 107, the MS generates and transmits a pilot strength measurement message (PSMM) to the source BS. The PSMM is a handoff request message by which the MS informs the source BS of the need for a handoff. The PSMM includes the measured PS and a pseudo noise (PN) offset of the neighboring BS. According to the handoff request message, the source BS determines if a handoff to the neighboring BS should be made, and transmits a handoff decision message to the MS.

In step 109, upon receipt of the handoff decision message, the MS performs the handoff to the neighboring BS. Thereafter, the MS ends the handoff process.

FIG. 2 is a schematic diagram illustrating a conventional handoff scheme. The following description is made of an FA that is used by the MS of FIG. 1 during the handoff.

Referring to FIG. 2, an MS 203, which is communicating with a first BS 201 using a first FA 211, uses a first FA 213 equal to the first FA 211 of the first BS 201. Thereafter, if the MS 203 receives a pilot signal of a second BS 205, it performs the process illustrated in FIG. 1. If the MS 203 performs a handoff to the second BS 205 as a result of the process of FIG. 1, it uses a second FA 214 equal to a second FA 215 of the second BS 205.

As described above, when the MS performs the handoff between BSs using different FAs, it temporarily disconnects communication with the source BS and communicates with the neighboring BS by accessing the FA of the neighboring BS (a Break and Make process). That is, the MS disconnects a current call channel and attempts a call over a new call channel. This leads to a temporary call interruption at a transition point between cells.

### SUMMARY OF THE INVENTION

An object of the present invention is to substantially solve at least the above problems and/or disadvantages and to provide at least the advantages below. Accordingly, an object of the present invention is to provide an apparatus and method for performing a handoff without call interruption in a cellular communication environment.

Another object of the present invention is to provide an apparatus and method for preventing call interruption in a cellular communication environment with a frequency reuse factor of N by using both of two neighboring FAs of two neighboring BSs.

A further object of the present invention is to provide an apparatus and method for minimizing a ping-pong effect of an MS in a cellular communication environment with a frequency reuse factor of N by using both of two neighboring FAs of two neighboring BSs.

According to an aspect of the present invention, there is provided a base station apparatus for performing a handoff in a broadband cellular communication system with a frequency reuse factor of N by simultaneously receiving signals of two neighboring FAs. In the base station apparatus, a handoff determiner determines whether an MS performs a handoff and simultaneously receives signals of the two neighboring FAs. If the MS simultaneously receives signals of the two neighboring FAs, a subcarrier mapper maps control information to subcarriers of a predetermined section so as to enable the MS to simultaneously receive the signals of the two neighboring FAs. An inverse fast Fourier transform (IFFT) processor IFFT-processes the control information mapped to the subcarriers.

According to another aspect of the present invention, there is provided a mobile station apparatus for performing a handoff in a broadband cellular communication system with a frequency reuse factor of N by simultaneously receiving signals of two neighboring FAs. In the mobile station apparatus, a handoff determiner determines a handoff according to the strengths of signals that are simultaneously received from first and second BSs using two neighboring FAs. If two signals of the first and second BSs are simultaneously received, a frequency controller selects a carrier for simultaneously receiving the two signals of the first and second BSs according to the determination of the handoff determiner. A local oscillator generates the carrier selected by the frequency controller. A multiplier multiplies the generated carrier from the local oscillator by a received signal to generate a baseband signal.

According to a further aspect of the present invention, there is provided a method for performing a handoff in a broadband cellular communication system with a frequency reuse factor of N by using both of two neighboring FAs. In the method, if a signal of a second BS using a neighboring FA is received during communication with a first BS, a difference between signal strengths of the first and second BSs is calculated to compare the difference with a predetermined threshold value. If the difference is smaller than the predetermined threshold value, a handoff for simultaneously allocating resources of the first and second BSs to a mobile station (MS) is requested. If portions of the resources of the first and second BSs are simultaneously allocated to the MS, signals of the two neighboring FAs are simultaneously received according to the handoff request.

### BRIEF DESCRIPTION OF THE DRAWINGS

The above and other objects, features, and advantages of the present invention will become more apparent from the following detailed description when taken in conjunction with the accompanying drawings in which:

FIG. 1 is a flowchart illustrating a conventional handoff process;

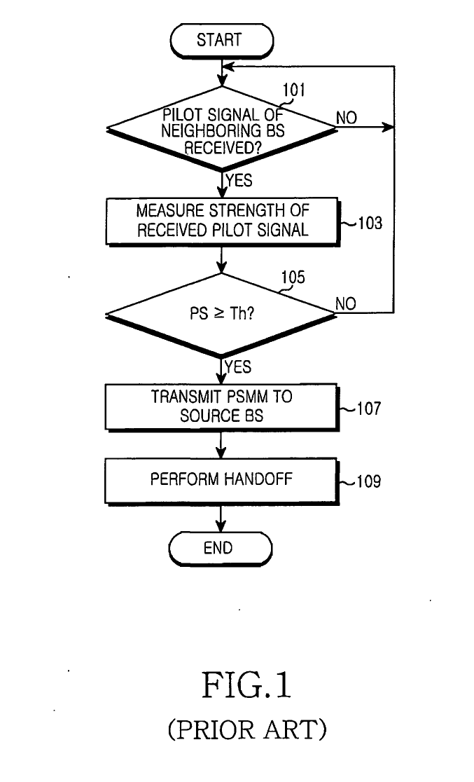

FIG. 2 is a schematic diagram illustrating a conventional handoff scheme;

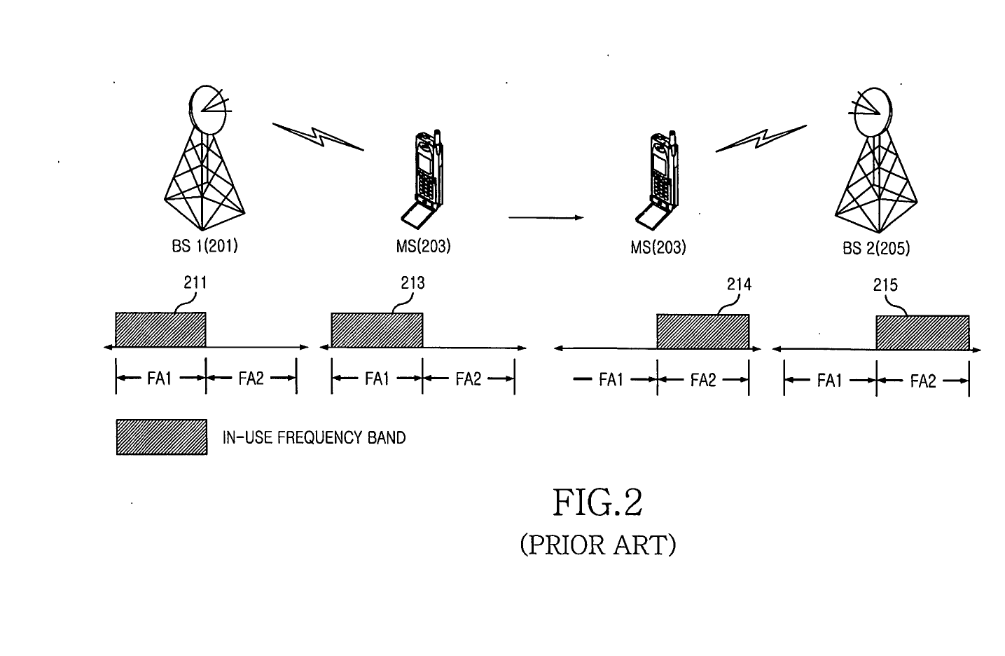

FIG. 3 is a schematic diagram illustrating a scheme for simultaneously receiving data signals from two BSs with neighboring FAs, according to the present invention;

FIG. 4 is a block diagram of a BS that enables an MS to perform a handoff procedure by simultaneously receiving data signals of two neighboring FAs, according to the present invention;

FIG. 5 is a block diagram of an MS for supporting band sliding according to the present invention;

FIG. 6 is a flowchart illustrating a handoff procedure of an MS according to the present invention; and

FIG. 7 is a flow diagram illustrating a handoff procedure in a broadband cellular communication system according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail because they would obscure the present invention in unnecessary detail.

The present invention provides an apparatus and method for performing a handoff without call interruption and minimizes a ping-pong effect of a mobile station (MS) in a cellular communication environment with a frequency reuse factor of N by using both of two neighboring frequency allocations (FAs) of two neighboring base stations (BSs). The ping-pong effect is a phenomenon in which an MS ping-pongs between cells without selecting one of the cells in a region where the MS can receive signals from two or more cells.

In the following description, the term “band sliding” means an operation of a handoff procedure in which an MS slides its in-use FA between two neighboring FAs of two neighboring BSs to simultaneously receive data signals of the two neighboring FAs.

The following description is made of an exemplary case where the handoff procedure including the band sliding operation is determined and requested by an MS. However, the present invention is not limited to such an exemplary case. For example, the handoff procedure including the band sliding operation may be determined by a BS.

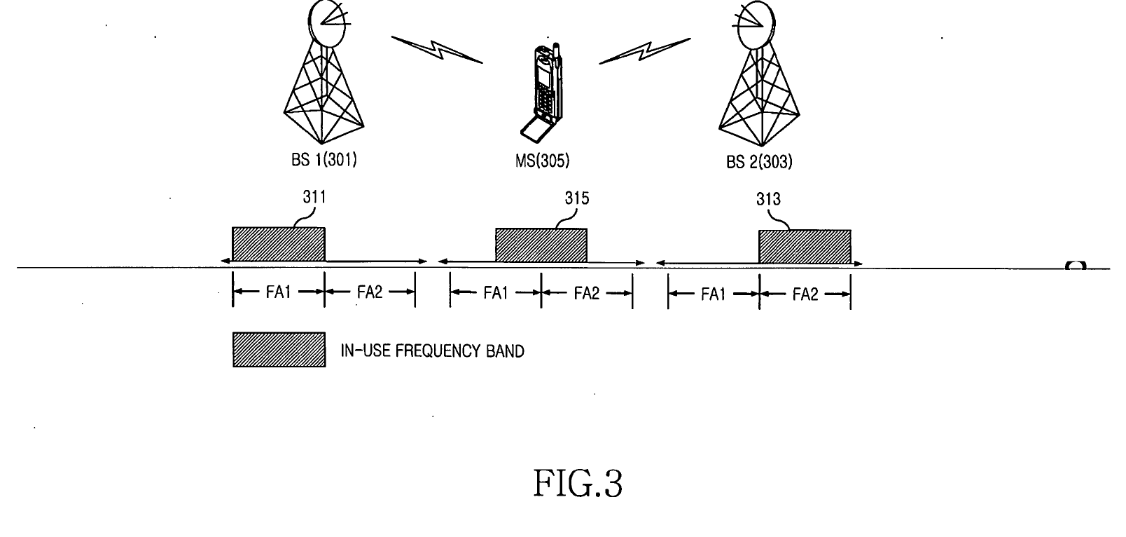

FIG. 3 is a schematic diagram illustrating a scheme for simultaneously receiving data signals from two neighboring BSs with different FAs, according to the present invention.

Referring to FIG. 3, first and second BSs 301 and 303 adjacent to each other use a first FA 311 and a second FA 313, respectively. The first and second FAs 311 and 313 are adjacent to each other. An MS 305 simultaneously receives data signals from the first and second BSs 301 and 303 by shifting its FA 315 such that the FA 315 includes both a portion of the first FA 311 and a portion of the second FA 313.

As illustrated in FIG. 3, in order for the MS 305 to successfully communicate with the two BSs 301 and 303, data frame structures transmitted from the two BSs 301 and 303 must support a data frame structure for receiving data by using only the portions of the two FAs. That is, even when the MS 305 receives only the portions of the two FAs, a frame structure capable of including the control information and the preamble of the frame.

Although not illustrated, in order for the MS 305 to receive data by using only the portions of the two FAs of the BSs 301 and 303, control information is located at a subcarrier in a predetermined section where the two FAs are adjacent to each other. That is, because the MS 305 receives data by using the neighboring portions of the two FAs of the BSs 301 and 303, the BSs 301 and 303 include the control information and the minimum bandwidth of a preamble for discriminating the BS at the portion of the FA received by the MS 305. At this point, in order to discriminate the BSs, the preamble is repeatedly mapped throughout the entire in-use FA of the BS to construct a frame.

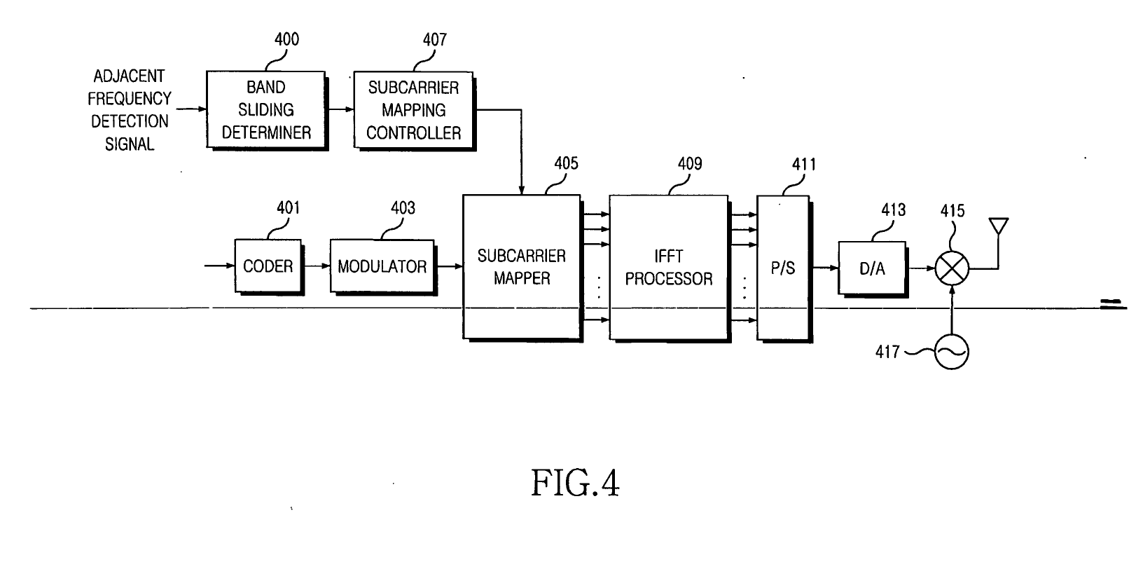

FIG. 4 is a block diagram of a BS that enables an MS to perform a handoff procedure by simultaneously receiving data signals of two neighboring FAs, according to the present invention.

Referring to FIG. 4, the BS includes a band sliding determiner 400, a coder 401, a modulator 403, a subcarrier mapper 405, a subcarrier mapping controller 407, an inverse FFT (IFFT) processor 409, a parallel-to-serial (P/S) converter 411, a digital-to-analog (D/A) converter 413, a multiplier 415, and a local oscillator 417.

The coder 401 receives information data from a medium access control (MAC) layer and performs channel-coding on input information data at a predetermined coding rate to output the resulting data to the modulator 403. The modulator 403 modulates the data from the coder 401 by a predetermined modulation scheme to output the resulting data to the subcarrier mapper 405. Examples of the predetermined modulation scheme are the binary phase shift keying (BPSK) modulation scheme, the quadrature phase shift keying (QPSK) modulation scheme, the 16-QAM (quadrature amplitude modulation) scheme, and the 64-QAM scheme.

The subcarrier mapper 405 performs a subcarrier-mapping operation on the data from the modulator 403 under the control of the subcarrier mapping controller 407 to output the resulting data (i.e., frequency-domain data) to the IFFT processor 409. When the band sliding determiner 400 receives a partial resource allocation request message from a mobile switching center (MSC), it outputs a band sliding control signal to the subcarrier mapping controller 407 so that the MS can perform a band sliding operation. Upon receipt of the band sliding control signal from the band sliding determiner 400, the subcarrier mapping controller 407 generates a control signal for mapping control information to a predetermined subcarrier where the two FAs are adjacent to each other, so that the MS can perform the band sliding operation by simultaneously receiving signals from the BS and another BS. The control sign is output to the subcarrier mapper 405.

The IFFT processor 409 IFFT-processes the frequency-domain data from the subcarrier mapper 405 to output time-sampled data (i.e., parallel data) to the P/S converter 411. The P/S converter 411 converts the parallel data from the IFFT processor 409 into serial data to output the resulting data (i.e., a digital signal) to the D/A converter 413. The D/A converter 413 converts the digital signal from the P/S converter 411 into an analog signal to output an analog baseband signal to the multiplier 415. The multiplier 415 multiplies the analog baseband signal from the D/A converter 413 by an oscillating signal from the local oscillator 417 to generate a radio-frequency (RF) signal. The multiplier 415 and the local oscillator 417 constitute an RF processor. The RF signal is transmitted through an antenna.

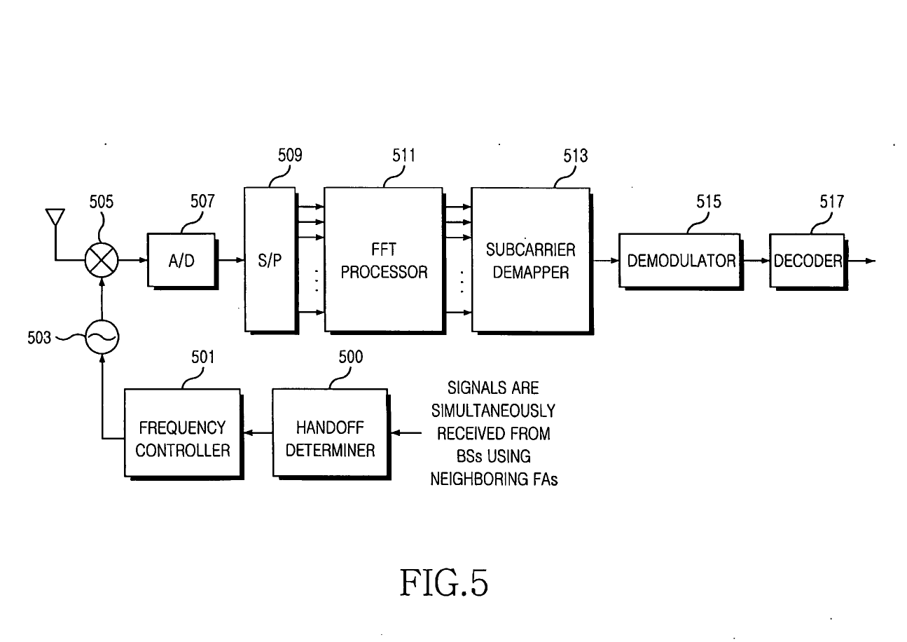

FIG. 5 is a block diagram of an MS supporting band sliding according to the present invention.

Referring to FIG. 5, the MS includes a handoff determiner 500, a frequency controller 501, a local oscillator 503, a multiplier 505, an analog-to-digital (A/D) converter 507, a serial-to-parallel (S/P) converter 509, an FFT processor 511, a subcarrier demapper 513, a demodulator 515, and a decoder 517.

When the MS simultaneously receives two signals from BSs using the neighboring FAs, the handoff determiner 500 determines whether to perform a band sliding operation, by comparing the absolute value of a difference between the two received signals (the PS from the source BS (PSs) minus the PS from the neighboring BS (PSn)) with a predetermined threshold value. When the absolute value is smaller than the predetermined threshold value (|PSs−PSn|<Th), the handoff determiner 500 determines that the band sliding operation is to be performed. On the other hand, when the absolute value is greater than or equal to the predetermined threshold value (|PSs−PSn|≧Th), the handoff determiner 500 determines to perform a handoff to the BS corresponding to the stronger of the two received signals. Depending on the determination results, the handoff determiner 500 sends a handoff request or a band sliding request to the MSC through the source BS. Thereafter, upon receipt of a handoff acknowledgement message or a band sliding acknowledgement message from the MSC, the MS performs a handoff operation or a band sliding operation.

The frequency controller 501 generates a control signal for selecting an FA to be used by the MS, and outputs the control signal to the local oscillation 503. That is, because the MS uses a predetermined bandwidth, the frequency controller 501 generates a control signal for selecting a carrier that is a center frequency of the MS. Also, when receiving a band sliding execution signal from the handoff determiner 500, the frequency controller 501 generates a control signal for selecting a carrier for simultaneously receiving data from the two neighboring BSs. The local oscillator 503 generates the carrier (i.e., the center frequency of the BS) under the control of the frequency controller 501. At this point, the carrier is selected such that it includes a preamble of the minimum bandwidth for discriminating between the BSs and control information of each of the two neighboring FAs.

The multiplier 505 multiplies a signal received through an antenna by a carrier received from the local oscillator 503, thereby creating an FA for simultaneously receiving signals from the two base stations. The A/D converter 507 converts an output signal from the multiplier 505 into a digital signal. The digital signal is time-sampled data (i.e., serial data).

The S/P converter 509 coverts the serial data from the A/D converter 507 into parallel data. The FFT processor 511 FFT-processes the parallel data from the S/P converter 509 to output frequency-domain data.

The subcarrier demapper 513 extracts subcarrier values loaded with actual data from the output signal (i.e., subcarrier values) of the FFT processor 511. According to the present invention, the actual data of each FA is extracted using control information that is loaded into a subcarrier of a predetermined section where the two FAs are adjacent to each other.

The demodulator 515 demodulates the actual data from the subcarrier demapper 513 by a predetermined demodulation scheme, which corresponds to the modulation scheme of the BS. The decoder performs a channel-decoding operation on the decoded data from the demodulator 515 at a predetermined coding rate, thereby restoring information data.

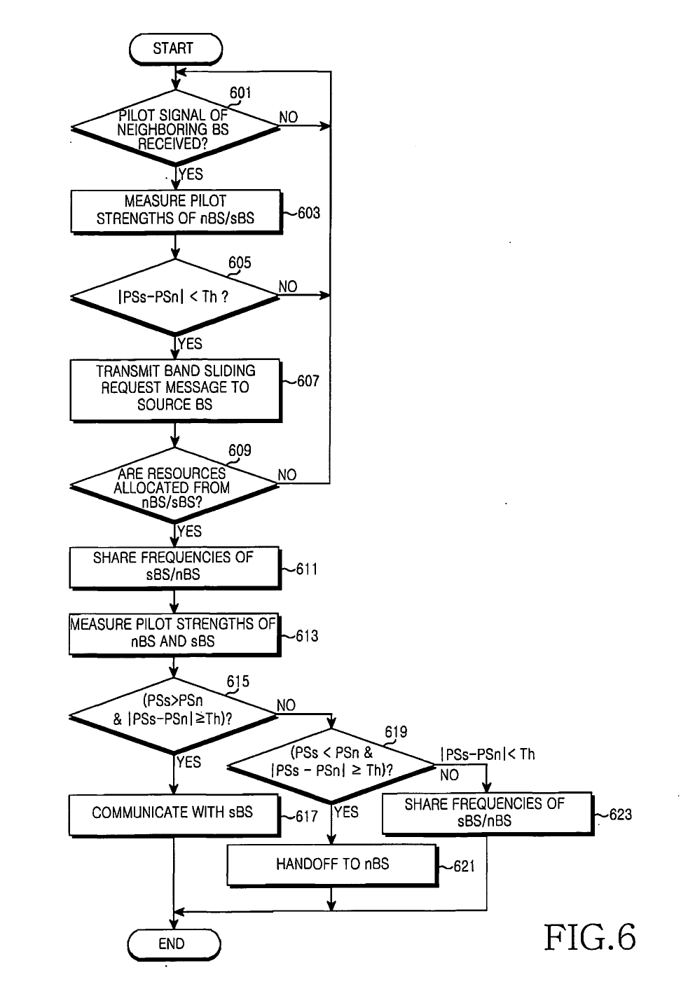

FIG. 6 is a flowchart illustrating a handoff procedure of an MS according to the present invention. The following description is made on the assumption that a source BS (sBS) and a neighboring BS (nBS) use FAs that are adjacent to each other. The source BS is a BS that the MS is communicating with, and the neighboring BS is a BS that neighbors the source BS and transmits a pilot signal to the MS.

Referring to FIG. 6, the MS determines in step 601 if it receives a pilot signal from the neighboring BS during communication with the source BS. If so, the BS proceeds to step 603, and if not, it performs step 601 again.

In step 603, the MS measures a pilot strength PSs of the source BS and a pilot strength PSn of the neighboring BS.

In step 605, the MS calculates a difference between the pilot strengths PSs and PSn and determines if the absolute value of the difference is greater than of equal to a threshold value. If so (|PSs−PSn|≧Th), the MS returns to step 601 to determine whether it receives a pilot signal from another neighboring BS, and if not (|PSs−PSn|<Threshold), the MS proceeds to step 607.

In step 607, the MS transmits a band sliding request message for a handoff operation to the source BS.

In step 609, the MS determines if it simultaneously receives allocated resources from the source BS and the neighboring BS. According to the resource allocation from the two BSs (i.e., sBS and nBS), the source BS, which has received the band sliding request message, sends a band sliding request to an MSC. Upon receipt of the band sliding request, the MSC requests the two BSs to perform a partial resource allocation on the MS because the FAs of the two BSs are adjacent to each other. Thereafter, upon receipt of the partial resource allocation request from the MSC, the two BSs perform the partial resource allocation on the MS. It is noted that band sliding is a scheme for partially sharing the FAs of the two adjacent BSs.

If the MS does not simultaneously receive the resources from the two BSs, it returns to step 601 to determine whether it receives a pilot signal from another neighboring BS.

On the other hand, if the MS simultaneously receives the resources from the two BSs, it proceeds to step 611 to simultaneously communicate with the source BS and the neighboring BS using both of the frequency resources of the two BSs.

In step 613, the MS again measures pilot strengths PSs and PSn of the two BSs.

In step 615, the MS compares the pilot strength PSs with the pilot strength PSn and determines if the pilot strength PSs is greater than the pilot signal strength PSn (PSs>PSn) and if the absolute value of a difference between the pilot strengths PSs and PSn is greater than or equal to the threshold value (|PSs−PSn|≧Th). If both conditions are satisfied (PSs>PSn & |PSs−PSn|≧Th), the MS proceeds to step 617, and if not, it proceeds to step 619.

In step 617, the MS communicates with the source BS by shifting its center frequency to the FA of the source BS and receiving the resources of the source BS.

In step 619, the MS determines if PSs<PSn and |PSs−PSn|≧Th. If these conditions are satisfied (PSs<PSn & |PSs−PSn|≧Th), the MS proceeds to step 621, and if not (|PSs−PSn|<Th), it proceeds to step 623.

In step 621, the MS communicates with the neighboring BS by shifting its center frequency to the FA of the neighboring BS and receiving the resources of the neighboring BS.

In step 623, the MS simultaneously communicates with the source BS and the neighboring BS using both of the frequency resources of the two BSs.

After the completion of step 617, 621 or 623, the MS ends the handoff procedure.

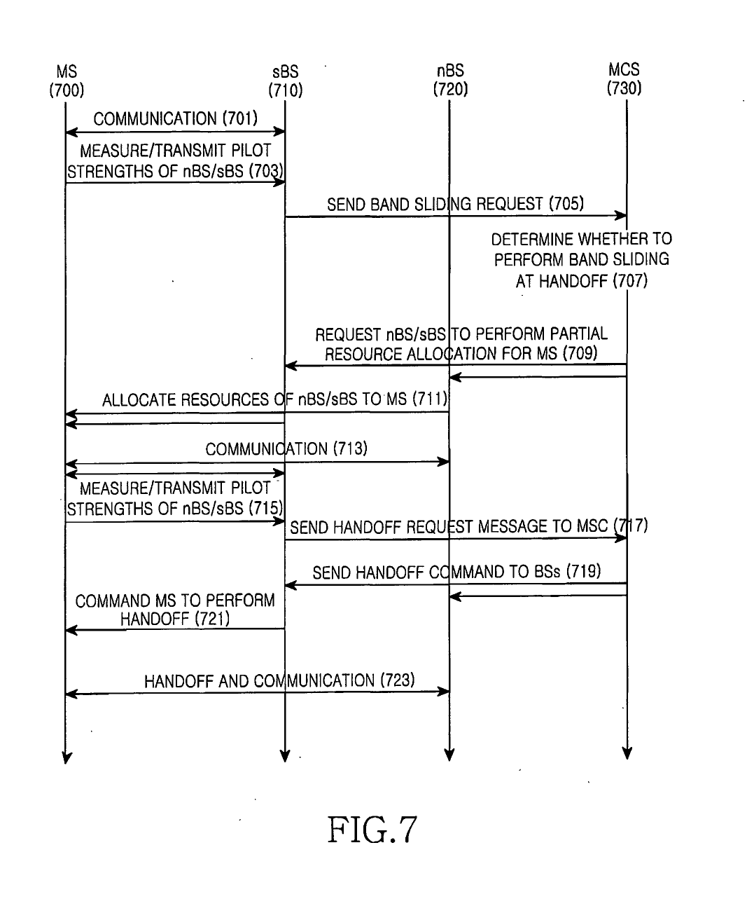

FIG. 7 is a flow diagram illustrating a handoff procedure in a broadband cellular communication system according to the present invention. The following description is made on the assumption that a source BS (sBS) and a neighboring BS (nBS) use FAs that are adjacent to each other. The source BS is a BS that the MS is communicating with, and the neighboring BS is a BS that neighbors the source BS and transmits a pilot signal to the MS.

Referring to FIG. 7, in step 701, an MS 700 receives and measures a pilot signal (PSs) of the source BS 710 and a pilot signal (PSn) of the neighboring BS 720 while communicating with the source BS 710. In step 703, the MS 703 calculates a difference (PSs−PSn) between the pilot signals of the BSs 710 and 720, compares the difference with a threshold value, and transmits a band sliding request message including the measurement results of the pilot signals to the source BS 710 if the absolute value of the difference is less than a threshold value (|PSs−PSn|<Th).

In step 705, upon receipt of the band sliding request message from the MS 700, the source BS 710 sends a band sliding request for a handoff to an MSC 730. In step 707, upon receipt of the band sliding request from the source BS 710, the MSC 730 detects the in-use frequencies of the BSs 710 and 720 to determine whether band sliding of the MS 700 should be performed. The MSC determines to perform band sliding if the BSs 710 and 720 have neighboring FAs that are adjacent to each other. On the other hand, if the BSs 710 and 720 do not have neighboring FAs, the MSC determines to perform a hard handoff.

In step 709, if the MSC determines to perform band sliding, it requests the BSs 710 and 720 to perform a partial resource allocation for the MS 700. In step 711, upon receipt of the partial resource allocation request from the MSC 730, the BSs 710 and 720 accordingly allocate resources to the MS 700.

Thereafter, in step 713, the MS 700 simultaneously communicates with the two BSs 710 and 720 by performing the band sliding operation to simultaneously receive resources from the BSs 710 and 720 as illustrated in FIG. 3.

Thereafter, in step 715, the MS 700 measures the pilot strength (PSs) of the source BS 710 and the pilot strength (PSn) of the neighboring BS 720 and provides the measurement results to the source BS 710. That is, the MS compares the PSs with the PSn, and requests a handoff to the neighboring BS 720 from the source BS 710 if the PSs is smaller than the PSn and the absolute value of the difference between the PSs and PSn is greater than or equal to a predetermined threshold value (PSs<PSn & |PSs−PSn|≧Th). Although not illustrated in FIG. 7, if PSs>PSn and |PSs−PSn|≧Th, the MS sends a request for a handoff to the source BS 710. Also, if |PSs−PSn|<Th, the MS 700 requests a communication using both of the FAs of the two BSs 710 and 720. That is, the MS 700 requests maintenance of the band sliding operation.

Thereafter, upon receipt of a handoff request from the MS 700, the source BS 710 sends a handoff request message to the MSC 730 in step 717.

In step 719, upon receipt of the handoff request message from the source BS 710, the MSC 730 sends a handoff command to the BSs 710 and 720. In step 721, upon receipt of the handoff command, the source BS 710 commands the MS 700 to perform a handoff to the neighboring BS 720. At this point, the neighboring BS 720 is ready for the handoff from the source BS 710 to it.

In step 723, the MS 700 performs a handoff to the neighboring BS 720 and communicates with the neighboring BS 720.

In the above embodiment, the MS 700 determines the handoff or band sliding and sends the handoff request or the band sliding request to the MSC 730. In another embodiment, the MS 700 measures the pilot strengths of the two BSs 710 and 720 and transmits the measurement results to the source BS 710. Upon receipt of the measurement results, the source BS 710 determines a handoff or a band sliding operation of the MS 700 to send a handoff request or a band sliding request to the MSC 730.

As described above, the present invention makes it possible to perform a handoff between the two neighboring BS without call interruption in a cellular communication environment with a frequency reuse factor of N by using both of the two neighboring FAs of the two neighboring BSs. Also, the present invention can reduce the ping-pong phenomenon, thereby improving the call quality of the MS. Also, the present invention can provide a diversity effect when the MS simultaneously receives the same data from the two neighboring BSs.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A base station (BS) apparatus for performing a handoff in a cellular communication system comprising:
a handoff determiner for determining whether a mobile station (MS) performs a handoff and simultaneously receives signals of the two neighboring FAs; and
a subcarrier mapper for mapping, if the MS simultaneously receives signals of the two neighboring frequency allocations (FAs), control information to subcarriers of a predetermined section so as to enable the MS to simultaneously receive the signals of the two neighboring FAs.

2. The base station apparatus of claim 1, further comprising:
an inverse fast Fourier transform (IFFT) processor for IFFT-processing the control information mapped to the subcarriers.

3. The base station apparatus of claim 1, further comprising:
a coder for receiving information data from a medium access control (MAC) layer and coding the received information data at a predetermined coding rate; and
a modulator for modulating the coded data from the coder at a predetermined modulation scheme and providing the resulting data to the subcarrier mapper.

4. The base station apparatus of claim 1, wherein the handoff determiner determines, through a partial resource allocation request message received from a mobile switching center (MSC), whether the MS has simultaneously received signals of the two neighboring FAs.

5. The base station apparatus of claim 1, wherein the control information includes a preamble and channel allocation information.

6. The base station apparatus of claim 1, wherein the subcarrier mapper repeatedly maps a preamble throughout an entire FA of the base station (BS).

7. The base station apparatus of claim 1, wherein the subcarrier mapper maps channel allocation information to subcarriers of a predetermined section where the two FAs are adjacent to each other.

8. The base station apparatus of claim 2, further comprising:
a digital-to-analog (D/A) converter for converting an output signal of the IFFT processor into an analog signal; and
a radio-frequency (RF) processor for converting a baseband analog signal from the D/A converter into an RF signal to output a resulting analog signal to the mobile station through an antenna.

9. A mobile station apparatus for performing a handoff in a cellular communication system comprising:
a handoff determiner for determining a handoff according to strengths of signals that are simultaneously received from first and second base stations (BSs) using two neighboring frequency allocations (FAs);
a frequency controller for selecting a carrier for simultaneously receiving the two signals of the first and second BSs according to the determination of the handoff determiner; and
a carrier generator for generating the carrier selected by the frequency controller.

10. The mobile station apparatus of claim 9 further comprising a multiplier for multiplying the generated carrier from the local oscillator by a received signal to generate a baseband signal.

11. The mobile station apparatus of claim 10, wherein the handoff determiner determines whether to simultaneously receive signals of the first and second BSs if an absolute value of a difference between the two received signals is less than a predetermined threshold value.

12. The mobile station apparatus of claim 10, wherein the frequency controller selects the carrier such that the carrier includes a preamble of a minimum bandwidth for discriminating between the first and second BSs and channel allocation information of each of the two neighboring FAs.

13. The mobile station apparatus of claim 10, further comprising:
an analog-to-digital (A/D) converter for converting the baseband signal from the multiplier into a digital signal;
a fast Fourier transform (FFT) processor for FFT-processing the digital signal from the A/D converter; and
a subcarrier demapper for receiving an output signal from the FFT processor and extracting actual data from the output signal from the FFT processor using control information mapped to a subcarrier of a predetermined section where the two FAs are adjacent to each other.

14. A method for performing a handoff in a cellular communication system comprising:
if a signal of a second base station (BS) using a neighboring frequency allocation (FA) is received during communication with a first BS, calculating a difference between signal strengths of the first and second BSs and comparing the difference with a predetermined threshold value;
if the difference is less than the predetermined threshold value, requesting a handoff for simultaneously allocating resources of the first and second BSs to a mobile station (MS); and
simultaneously receiving signals of the two neighboring FAs according to the handoff request.

15. The method of claim 14, further comprising, if signals of the two neighboring FAs are simultaneously received:
measuring and comparing strengths of the signals of the two neighboring FAs; and
if the signal strength of the first BS is less than the signal strength of the second BS and if an absolute value of a difference between the two signal strengths is greater than or equal to the predetermined threshold value, requesting a handoff to the second BS.

16. The method of claim 15, further comprising requesting a handoff to the first BS if the signal strength of the first BS is greater than the signal strength of the second BS and if the absolute value of the difference between the two signal strengths is greater than or equal to the predetermined threshold value.

17. The method of claim 15, further comprising continuing to simultaneously receives the signals of the two neighboring FAs if an absolute value of a difference between the two signal strengths is less than the predetermined threshold value.

18. A method for operating a cellular communication system comprising:
if a mobile station (MS) receives a signal from a second base station (BS) during communication with a first BS, sending a handoff request from the MS to a mobile switching center (MSC) via the first BS by comparing signal strengths of the first and second BSs;
upon receipt of the handoff request by the MSC, requesting, at the MSC, the first and second BSs to perform a partial resource allocation for the MS if in-use frequency allocations (FAs) of the first and second BSs are adjacent to each other;
allocating, from the first and second BSs, resources to the MS according to the partial resource allocation request; and
sharing, at the MS, the FAs of the first and second BSs if the resources of the first and second BSs are simultaneously allocated to the MS.

19. The method of claim 18, wherein the step of sending the handoff request to the MSC comprises:
calculating a difference between signal strengths of the first and second BSs and comparing the difference with a predetermined threshold value;
if the difference is less than the predetermined threshold value, sending a handoff request through the first BS to the MSC so that the resources of the first and second BSs are simultaneously allocated to the MS.

20. The method of claim 18, wherein the MSC commands the first and second BSs to perform a hard handoff if the in-use frequencies the first and second BSs are not adjacent to each other.

21. The method of claim 18, further comprising, if the MS uses both of the FAs of the first and second BSs:
measuring and comparing signal strengths of the first and second BSs; and
if an absolute value of a difference between the signal strengths of the first and second BSs is less than a predetermined threshold value, continuing to simultaneously receive signals of the first and second BSs at the MS.

22. The method of claim 21, further comprising requesting, at the MS, a handoff to the first BS if the signal strength of the first BS is greater than the signal strength of the second BS and if the difference between the two signal strengths is greater than or equal to the predetermined threshold value.

23. The method of claim 21, further comprising requesting, at the MS, a handoff to the second BS if the signal strength of the second BS is greater than the signal strength of the first BS and if the difference between the two signal strengths is greater than or equal to the predetermined threshold value.
